(19) United States
(12) Patent Application Publication
(10) Pub. No.: US 2026/0068920 A1
(43) Pub. Date: Mar. 12, 2026

(54) FOOD FORMING APPARATUS

(71) Applicant: ANKO FOOD MACHINE CO., LTD., New Taipei City (TW)

(72) Inventors: CHUNG MING CHANG, New Taipei City (TW); CHIN WEI YU, New Taipei City (TW)

(21) Appl. No.: 18/936,990

(22) Filed: Nov. 4, 2024

(30) Foreign Application Priority Data
Sep. 9, 2024 (TW) 113209762

(51) Int. Cl. A23P 30/10; A21C 11/00

(52) U.S. Cl. CPC A23P 30/10; A21C 11/006

(57) ABSTRACT

Provided is a food forming apparatus. The food forming apparatus includes a power unit, a first transmission mechanism, a second transmission mechanism, a first forming mold assembly and a second forming mold assembly. The first transmission mechanism and the second transmission mechanism are respectively connected to the power unit. The first forming mold assembly and the second forming mold assembly are respectively connected to the first transmission mechanism and the second transmission mechanism to perform rotational motions and linear motions. The first forming mold assembly and the second forming mold assembly are respectively driven by the first transmission mechanism and the second transmission mechanism to simultaneously perform reverse linear motions and reverse rotational motions.

### FIELD OF THE INVENTION

The present invention relates to a food forming apparatus, and more particularly, applied in food processing machinery, to solve the technical problem caused by the complex components of the food forming apparatus.

### BACKGROUND OF THE INVENTION

In the prior art, for the forming apparatus of pie (Empanada) type food, generally, a whole pack of mexican pie generally comprises stuffing sandwiched between two tortillas, or a slice of tortilla folded as a half-circle (stuffing is in the middle). Generally, for the half-circle mexican pie, first, the wrapper (slightly larger than the final product) is placed on two molds; then, the stuffing is placed on the wrapper; and finally, the final product is formed by combining the two molds. However, in the prior arts, the two molds are respectively driven and controlled by independent two power sources, thus more power sources (motors) are required and leads to increased costs, complicated control, and maintenance problems caused by various mechanisms.

Therefore, it is necessary to provide a food forming apparatus that does not require multiple power sources to solve the many shortcomings as aforementioned.

### SUMMARY OF INVENTION

For solving the aforesaid problems of the prior arts, the present invention provides a food forming apparatus merely utilizing one single power source, which can significantly reduce the costs, simplify the control and reduce components. The present invention does not require frequent maintenance and can improve the availability and production efficiency of the food forming apparatus.

The food forming apparatus of the present invention comprises a power unit, a first transmission mechanism, a second transmission mechanism, a first forming mold assembly and a second forming mold assembly. The first transmission mechanism and the second transmission mechanism are respectively connected to the power unit. The first forming mold assembly and the second forming mold assembly are respectively connected to the first transmission mechanism and the second transmission mechanism to perform rotational motions and linear motions. The first forming mold assembly and the second forming mold assembly are respectively driven by the first transmission mechanism and the second transmission mechanism to simultaneously perform reverse linear motions and reverse rotational motions.

In the embodiment of the present invention, the first transmission mechanism comprises a first linear motion mechanism and a first rotational motion mechanism; the first rotational motion mechanism is directly connected to and drives the first forming mold assembly to rotate. The second transmission mechanism comprises a second linear motion mechanism and a second rotational motion mechanism; the second rotational motion mechanism is directly connected to and drives the second forming mold assembly to rotate.

In the embodiment of the present invention, the first linear motion mechanism drives the first forming mold assembly to perform the linear motions. The second linear motion mechanism drives the second forming mold assembly to perform the linear motions.

In the embodiment of the present invention, the power unit is sequentially connected to the first linear motion mechanism, the first rotational motion mechanism and the first forming mold assembly. Meanwhile, the power unit is sequentially connected to the second linear motion mechanism, the second rotational motion mechanism and the second forming mold assembly.

In the embodiment of the present invention, the first transmission mechanism comprises a first chain and a first concentric rotating shaft. The second transmission mechanism comprises a second chain and a second concentric rotating shaft.

In the embodiment of the present invention, the first forming mold assembly comprises a plurality of first molds and a first rotating bracket, and the plurality of first molds are arranged on the first rotating bracket. The second forming mold assembly comprises a plurality of second molds and a second rotating bracket, and the plurality of second molds are arranged on the second rotating bracket.

In the embodiment of the present invention, the first rotating bracket is connected to the first transmission mechanism to pivot. The second rotating bracket is connected to the second transmission mechanism to pivot.

Compared with the prior arts, the present invention merely utilizes one single power unit, which is connected to the first transmission mechanism and the second transmission mechanism, respectively, and then is connected to and drives the first forming mold assembly and the second forming mold assembly to perform reverse linear motions and reverse rotational motions. Accordingly, the present invention can significantly reduce the costs, simplify the control and reduce components. The present invention does not require frequent maintenance and can improve the availability and production efficiency of food forming apparatus.

### BRIEF DESCRIPTION OF THE ACCOMPANYING DRAWINGS

FIG. 1 depicts a diagram of an entire machine comprising a sandwich-stuffing food forming apparatus according to the present invention;

FIG. 1 depicts a perspective view diagram of the food forming apparatus according to the present invention.

FIG. 2 depicts a front view diagram of the food forming apparatus according to the present invention.

FIG. 3A depicts a front view diagram of the upper side of the food forming apparatus according to the present invention, wherein the rotation angle of the first forming mold assembly and the second forming mold assembly is 0 degrees.

FIG. 3B depicts a front view diagram of the upper side of the food forming apparatus according to the present invention, wherein the rotation angle of the first forming mold assembly and the second forming mold assembly is 20 degrees.

FIG. 3C depicts a front view diagram of the upper side of the food forming apparatus according to the present invention, wherein the rotation angle of the first forming mold assembly and the second forming mold assembly is 45 degrees.

FIG. 3D depicts a front view diagram of the upper side of the food forming apparatus according to the present invention, wherein the rotation angle of the first forming mold assembly and the second forming mold assembly is 70 degrees.

### DETAILED DESCRIPTION OF PREFERRED EMBODIMENTS

The following descriptions of the embodiments refer to the appended figures to illustrate specific embodiments in which the present invention may be implemented. The directional terms of up, down, front, rear, left, right, interior, exterior, side, etcetera mentioned in the present invention are merely directions of referring to appended figures. Therefore, the aforesaid directional terms are employed for explaining and understanding the present invention, but the present invention is not limited thereto.

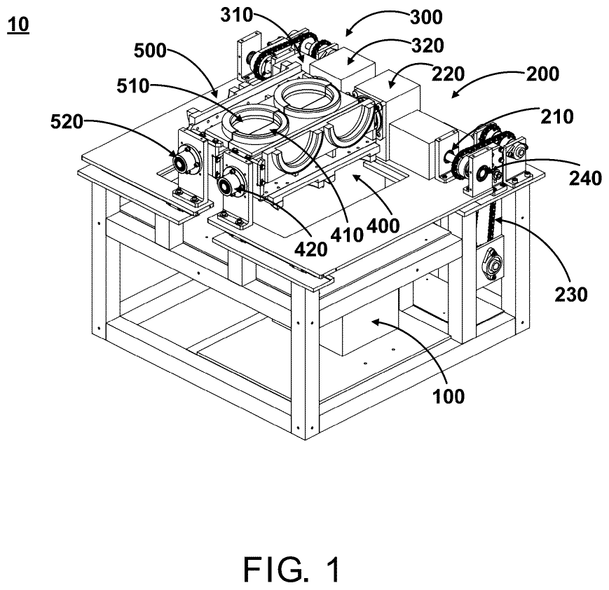

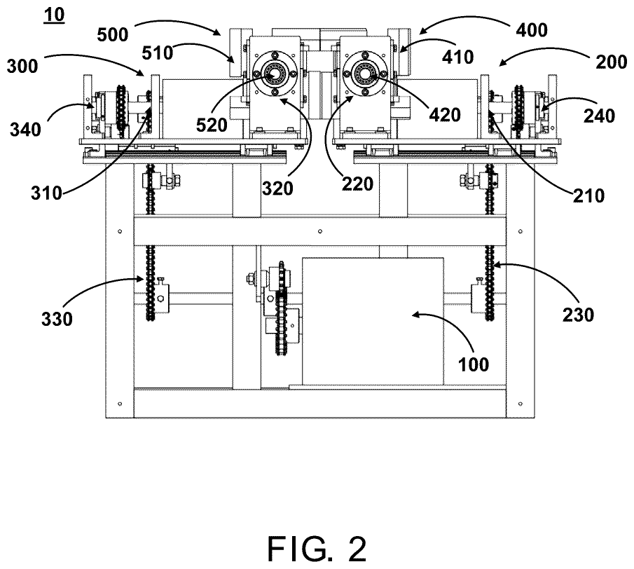

Please refer to FIG. 1 and FIG. 2. FIG. 1 depicts a perspective view diagram of the food forming apparatus 10 according to the present invention. FIG. 2 depicts a front view diagram of the food forming apparatus 10 according to the present invention. The food forming apparatus 10 of the present invention comprises a power unit 100, a first transmission mechanism 200, a second transmission mechanism 300, a first forming mold assembly 400 and a second forming mold assembly 500. The first transmission mechanism 200 and the second transmission mechanism 300 are respectively connected to the power unit 100. The first forming mold assembly 400 and the second forming mold assembly 500 are respectively connected to the first transmission mechanism 200 and the second transmission mechanism 300 to perform rotational motions and linear motions. The first forming mold assembly 400 and the second forming mold assembly 500 are respectively driven by the first transmission mechanism 200 and the second transmission mechanism 300 to simultaneously perform reverse linear motions and reverse rotational motions.

The first transmission mechanism 200 comprises a first linear motion mechanism 210 and a first rotational motion mechanism 220; the first rotational motion mechanism 220 is directly connected to and drives the first forming mold assembly 400 to rotate. The second transmission mechanism 300 comprises a second linear motion mechanism 310 and a second rotational motion mechanism 320; the second rotational motion mechanism 320 is directly connected to and drives the second forming mold assembly 500 to rotate. The first linear motion mechanism 210 drives the first forming mold assembly 400 to perform the linear motions. The second linear motion mechanism 310 drives the second forming mold assembly 500 to perform the linear motions.

As shown in FIG. 1 and FIG. 2, the power unit 100 is sequentially connected to the first linear motion mechanism 210, the first rotational motion mechanism 220 and the first forming mold assembly 400. Meanwhile, the power unit 100 is sequentially connected to the second linear motion mechanism 310, the second rotational motion mechanism 320 and the second forming mold assembly 500. The first transmission mechanism 200 further comprises a first chain 230 and a first concentric rotating shaft 240.The second transmission mechanism 300 further comprises a second chain 330 and a second concentric rotating shaft 340. Namely, the power unit 100 transmits the power through a combination design of the plurality of first chains 230, the first linear motion mechanism 210 of the first transmission mechanism 200, the first rotational motion mechanism 220 and the first concentric rotating shaft 240. Correspondingly and simultaneously, the power unit 100 transmits the power through a combination design of the plurality of second chains 330, the second linear motion mechanism 310 of the second transmission mechanism 300, the second rotational motion mechanism 320 and the second concentric rotating shaft 340. Thereby, the power unit 100 synchronously drives the first forming mold assembly 400 and the second forming mold assembly 500 to perform reverse linear motions and reverse rotational motions (described in further detail below). Furthermore, the power transmission of the combination design of the aforesaid respective components is well known to those familiar with the field of mechanical design. For instance, cams and any other required mechanical components may be provided in the first transmission mechanism 200 and the second transmission mechanism 300 to synchronize and integrate the coordination of linear motion and rotational motion, which will not be described in detail here.

As shown in FIG. 1 and FIG. 2, the first forming mold assembly 400 comprises a plurality of first molds 410 and a first rotating bracket, 420 and the plurality of first molds 410 are arranged on the first rotating bracket 420. The appearance of the first forming mold assembly 400 is a rectangular body with four sides. As shown in the figure, the plurality of first molds 410 can be provided on the four sides of the rectangular body. The figure shows that two first molds 410 are provided on each side of the rectangular body, but the amount of the molds is not limited thereto. The first rotating bracket 420 is directly connected to the first rotational motion mechanism 220 of the first transmission mechanism 200 to pivot. Accordingly, the plurality of first molds 410 then rotate.

As shown in FIG. 1 and FIG. 2, the second forming mold assembly 500 comprises a plurality of second molds 510 and a second rotating bracket 520, and the plurality of second molds 510 are arranged on the second rotating bracket 520. The appearance of the second forming mold assembly 500 is a rectangular body with four sides. As shown in the figure, the second molds 510 can be provided on the four sides of the rectangular body. The figure shows that two second molds 510 are provided on each side of the rectangular body, but the amount of the molds is not limited thereto. The second rotating bracket 520 is directly connected to the second rotational motion mechanism 320 of the second transmission mechanism 300 to pivot. Accordingly, the plurality of second molds 510 then rotate.

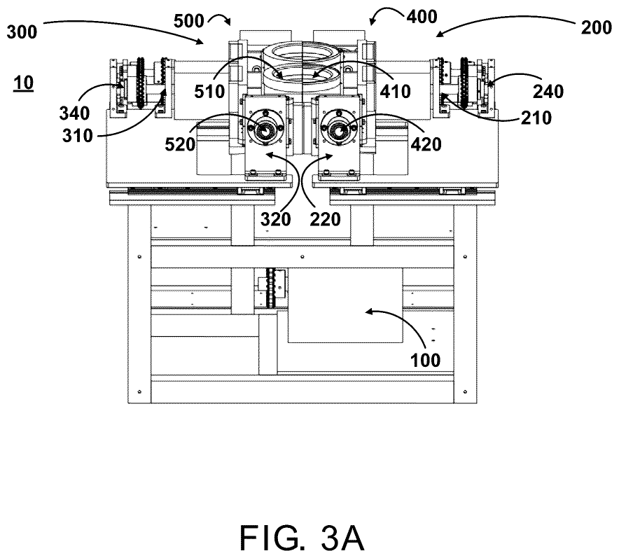

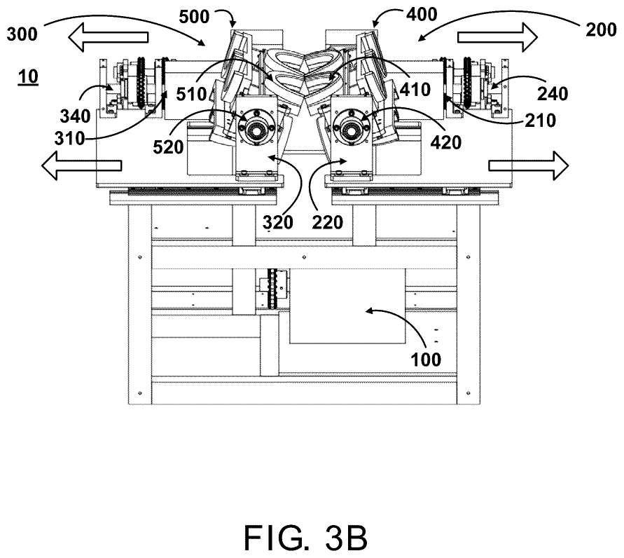

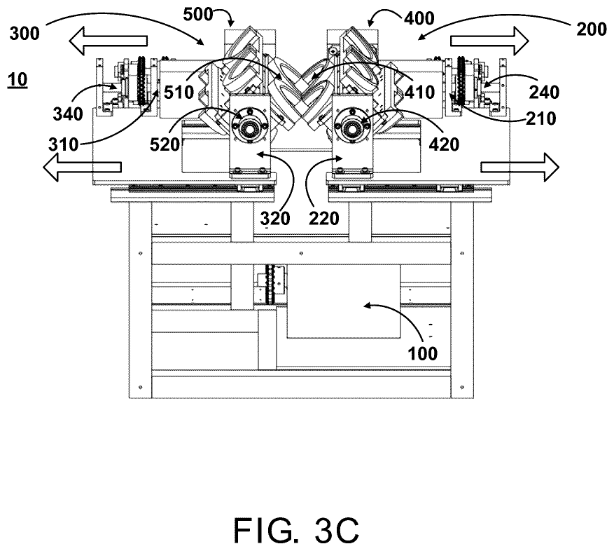

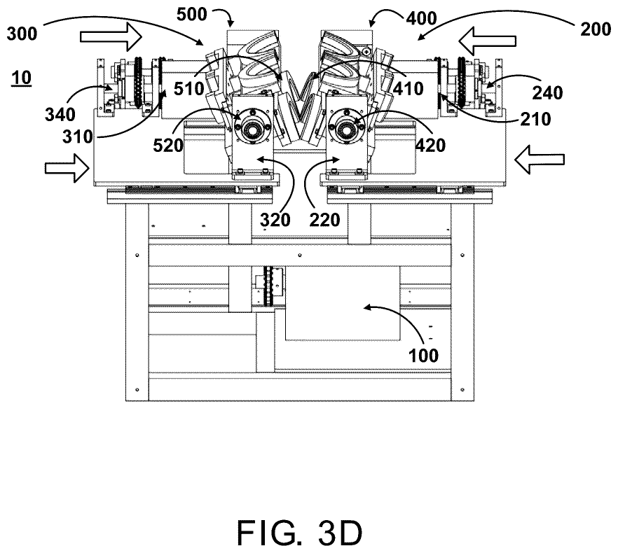

Please refer to FIGS. 3A to 3D, which depict front view diagrams of the upper side of the food forming apparatus 10 according to the present invention. In FIG. 3A, the respective rotation angles of the first forming mold assembly 400 and the second forming mold assembly 500 toward the center are 0 degrees. In FIG. 3B, the respective rotation angle of the first forming mold assembly 400 and the second forming mold assembly 500 toward the center are 20 degrees. In FIG. 3C, the respective rotation angle of the first forming mold assembly 400 and the second forming mold assembly 500 toward the center are 45 degrees. In FIG. 3D, the respective rotation angle of the first forming mold assembly 400 and the second forming mold assembly 500 toward the center are 70 degrees.

As shown in FIG. 1, FIG. 2 and FIG. 3A, as the respective rotation angles of the first forming mold assembly 400 and the second forming mold assembly 500 toward the center are 0 degrees, the foregoing first molds 410 (semi-circle) and the second molds 510 (semi-circle) merge to form upward circular grooves.

As shown in FIG. 1, FIG. 2 and FIG. 3A, the state that the first forming mold assembly 400 and the second forming mold assembly 500 rotate toward the center of the food forming apparatus 10 at 0 degrees can be defined as an initial state. In this initial state, a plurality of wrappers (not shown) are placed in the plurality of upward circular grooves formed by the plurality of first molds 410 (semi-circle) and the plurality of second molds 510 (semi-circle). Then, after placing the stuffings on the wrappers, as aforementioned, the single power unit 100 of the present invention is employed to simultaneously and synchronously drive the first transmission mechanism 200 and the second transmission mechanism 300.

Then, as shown in FIG. 3B, the respective rotation angles of the first forming mold assembly 400 and the second forming mold assembly 500 toward the center of the food forming apparatus 10 are 20 degrees. While the first rotational motion mechanism 220 and the second rotational motion mechanism 320 drive the first forming mold assembly 400 and the second forming mold assembly 500 to perform reverse rotational motions, as shown by the transparent arrows in FIG. 3B, the first linear motion mechanism 210 and the second linear motion mechanism 310 extend outward, and meanwhile drive the first concentric rotating shaft 240 and the second concentric rotating shaft 340 to extend outward (as shown in the figure, the first transmission mechanism 200 and the first forming mold assembly 400 are arranged on a platform, and the platform slides to the right; the second transmission mechanism 300 and the second forming mold assembly 500 are arranged on a platform, and the platform slides to the left.). Thus, the reverse linear motions of the first linear motion mechanism 210 and the second linear motion mechanism 310 can prevent the first molds 410 and the second molds 510 from contacting each other and causing interference when the first forming mold assembly 400 and the second forming mold assembly 500 perform the reverse rotational motions, i.e. the first rotating bracket 420 and the second rotating bracket 520 perform reverse pivotings.

Then, as shown in FIG. 3C, the respective rotation angles of the first forming mold assembly 400 and the second forming mold assembly 500 toward the center of the food forming apparatus 10 are 45 degrees. While the first rotational motion mechanism 220 and the second rotational motion mechanism 320 drive the first forming mold assembly 400 and the second forming mold assembly 500 to perform reverse rotational motions, as shown by the transparent arrows in FIG. 3C, the first linear motion mechanism 210 and the second linear motion mechanism 310 continue to extend outward, and meanwhile drive the first concentric rotating shaft 240 and the second concentric rotating shaft 340 to continue to extend outward (as shown in the figure, the platform, which the first transmission mechanism 200 and the first forming mold assembly 400 are arranged on, slides to the right to its maximum limit; the platform, which the second transmission mechanism 300 and the second forming mold assembly 500 are arranged on, slides to the left to its maximum limit.). Thus, the reverse linear motions of the first linear motion mechanism 210 and the second linear motion mechanism 310 still can prevent the first molds 410 and the second molds 510 from contacting each other and causing interference when the first forming mold assembly 400 and the second forming mold assembly 500 perform the reverse rotational motions, i.e. the first rotating bracket 420 and the second rotating bracket 520 perform the reverse pivotings.

Then, as shown in FIG. 3D, the respective rotation angles of the first forming mold assembly 400 and the second forming mold assembly 500 toward the center of the food forming apparatus 10 are 70 degrees. As shown in FIG. 3C, the reverse linear motions of the first linear motion mechanism 210 and the second linear motion mechanism 310 have reached their maximum limits. After the reverse rotational motions of the first molds 410 and the second molds 510 exceed 45 degrees, i.e. the reverse pivotings of the first rotating bracket 420 and the second rotating bracket 520 exceed 45 degrees, as shown by the transparent arrows in FIG. 3D, the first linear motion mechanism 210 and the second linear motion mechanism 310 will retract inward, and meanwhile drive the first concentric rotating shaft 240 and the second concentric rotating shaft 340 to retract inward (as shown in the figure, the platform, which the first transmission mechanism 200 and the first forming mold assembly 400 are arranged on, slides to the left; the platform, which the second transmission mechanism 300 and the second forming mold assembly 500 are arranged on, slides to the right.). Thus, the reverse linear motions of the first linear motion mechanism 210 and the second linear motion mechanism 310 can drive the first molds 410 and the second molds 510 to gradually close over each other when the first forming mold assembly 400 and the second forming mold assembly 500 perform the reverse rotational motions, i.e. the first rotating bracket 420 and the second rotating bracket 520 perform reverse pivotings. The half-moon shaped pie (Empanada) type food, which the wrapper is folded with the stuffing inside, is finally accomplished.

Furthermore, as shown in FIG. 3D, as the half-moon shaped pie, which the wrapper is folded with the stuffing inside, is accomplished and these first molds 410 and these second molds 510 close over each other, the first molds 410 (semi-circle) and the second molds 510 (semi-circle) arranged on the other side of the four-sides rectangular body merge to form upward circular grooves. Therefore, the food molding apparatus 10 becomes the defined initial state as aforementioned, again. Therefore, in this initial state, the wrappers are placed and then, the stuffings are placed on the wrappers, again. The operation cycles of the power unit 100 on the first transmission mechanism 200, the second transmission mechanism 300, the first forming mold assembly 400 and the second forming mold assembly 500 shown in FIGS. 3A to 3D are repeated once again.

Compared with the prior arts, the food forming apparatus 10 of the present invention merely utilizes one single power unit 100, which is connected to the first transmission mechanism 200 and the second transmission mechanism 300, respectively, and then is connected to and drives the first forming mold assembly 400 and the second forming mold assembly 500 to perform the reverse linear motions and the reverse rotational motions. Accordingly, the present invention can significantly reduce the costs, simplify the control and reduce components. The present invention does not require frequent maintenance and can improve the availability and production efficiency of food forming apparatus.

Above are only preferred embodiments of the present invention, and it should be noted that to any persons who are skilled in the art, improvement and modification which is easily derived should be covered by the protected scope of the application. Thus, the protected scope of the application should go by the subject claims, including the improvement and the modification.

What is claimed is:

1. A food forming apparatus, comprising:
a power unit;
a first transmission mechanism and a second transmission mechanism, respectively connected to the power unit; and
a first forming mold assembly and a second forming mold assembly, respectively connected to the first transmission mechanism and the second transmission mechanism to perform rotational motions and linear motions.

2. The food forming apparatus according to claim 1, wherein the first forming mold assembly and the second forming mold assembly are respectively driven by the first transmission mechanism and the second transmission mechanism to simultaneously perform the reverse linear motions and the reverse rotational motions.

3. The food forming apparatus according to claim 1, wherein the first transmission mechanism comprises a first linear motion mechanism and a first rotational motion mechanism; the first rotational motion mechanism is directly connected to and drives the first forming mold assembly to rotate.

4. The food forming apparatus according to claim 3, wherein the first linear motion mechanism drives the first forming mold assembly to perform the linear motions.

5. The food forming apparatus according to claim 3, wherein the power unit is sequentially connected to the first linear motion mechanism, the first rotational motion mechanism and the first forming mold assembly.

6. The food forming apparatus according to claim 1, wherein the first transmission mechanism comprises a first chain and a first concentric rotating shaft.

7. The food forming apparatus according to claim 1, wherein the first forming mold assembly comprises a plurality of first molds and a first rotating bracket, and the plurality of first molds are arranged on the first rotating bracket.

8. The food forming apparatus according to claim 7, wherein the first rotating bracket is connected to the first transmission mechanism to pivot.

9. The food forming apparatus according to claim 1, wherein the second transmission mechanism comprises a second linear motion mechanism and a second rotational motion mechanism; the second rotational motion mechanism is directly connected to and drives the second forming mold assembly to rotate.

10. The food forming apparatus according to claim 9, wherein the second linear motion mechanism drives the second forming mold assembly to perform the linear motions.

11. The food forming apparatus according to claim 9, wherein the power unit is sequentially connected to the second linear motion mechanism, the second rotational motion mechanism and the second forming mold assembly.

12. The food forming apparatus according to claim 1, wherein the second transmission mechanism comprises a second chain and a second concentric rotating shaft.

13. The food forming apparatus according to claim 1, wherein the second forming mold assembly comprises a plurality of second molds and a second rotating bracket, and the plurality of second molds are arranged on the second rotating bracket.

14. The food forming apparatus according to claim 13, wherein the second rotating bracket is connected to the second transmission mechanism to pivot.
